(19) United States
(12) Patent Application Publication
(10) Pub. No.: US 2009/0273947 A1
(43) Pub. Date: Nov. 5, 2009

(54) Surface light source device and display

(75) Inventor: Susumu Takada, Tokyo (JP)

Correspondence Address: STAAS & HALSEY LLP, SUITE 700, 1201 NEW YORK AVENUE, N.W., WASHINGTON, DC, 20005, US

(73) Assignee: ENPLAS CORPORATION, Kawaguchi (JP)

(21) Appl. No.: 11/984,423

(22) Filed: Nov. 16, 2007

(30) Foreign Application Priority Data
Nov. 16, 2006 (JP) 310369/2006

(51) Int. Cl. F21V 7/22

(52) U.S. Cl. 362/611

(57) ABSTRACT

Members including light guide plate 4 and others are accommodated in frame 23. Primary light emitted from point—like light source(s) (LED(s)) 14 is supplied to incidence face 6 of light guide plate 4 through window(s) 31 with which frame 23 provided. Positioning—projections formed on incidence face 6 are put into light-guide-plate-positioning-holes 24 with which frame 23 provided, restricting movement of light guide plate 4. Each window 31 of frame 23 has upper portion and lower portion which shade edges of upper and lower ends of incidence face 6, respectively. This prevents a part of the primary light from entering into light guide plate 4 via any edge of upper or lower ends of incidence face 6, avoiding abnormal emission from occurring. Another light guide plate 5 disposed at the back side of light guide plate 4 may be supplied with light generally in the same way.

### BACKGROUND OF INVENTION

1. Field of Invention

The present invention relates to a surface light source device and to a display employing the surface light source device. The present invention can be applied to displays in devices such as car navigation devices, video cameras, digital still cameras, electronic pocket notebooks, portable telephones, portable mobile terminal devices, personal computers, or LCD-TV sets.

The present invention can be also applied to surface light source devices for backlighting a member—to—be—illuminated (such as LCD-panel) in the above displays, or to surface light source devices for backlighting an advertising panel or the like. The present invention is suitably applied to, for example, surface light source devices of a type such that white illumination output light is provided by adopting LEDs emitting light of a plurality of colors as primary light source, and displays (such as car navigation devices, video cameras) employing the same,

2. Related Arts

Known devices such as car navigation devices have employed displays each consisting of a LCD-panel and a surface light source device for backlighting the LCD-panel. In general, surface light source device include a thin light guide plate and a rod-like fluorescent lamp (primary light source) disposed along a side face (incidence face). Light (primary light) from the fluorescent lamp enters into the light guide plate through the incidence face, becoming inner propagation light. Emission is provided by an emission face generally vertical to the incidence face on the way of inner propagation.

In general, However, employment of fluorescent lamp as primary light source brings problems like (1) to (3) below.

(1) Environment is affected when fluorescent lamps are disposed because they contain mercury.

(2) Electric power consumption is large.

(3) A driving circuit including an inverter is required.

Under such situation, it has been proposed, as disclosed in Patent Document 1 noted below, to employ a so-called “white LED” instead of fluorescent lamp, and white LEDs have been put into practical use. A white LED is a light emitting means outputting white light, which has been realized because blue LEDs have been put in practical use.

If a white LED(s) is(are) employed as a primary light source of a surface light source device, the above problems are overcome.

According to a proposition, structure as shown in FIG. 17 is employed in a surface light source device of side light type including LEDs are disposed at an end side of a light guide plate in order to have light from the LEDs enter into the light guide plate at a high efficiency and to reduce unevenness in brightness which is caused by short of light quantity at a location(s) corresponding to a section(s) between a LED and another LED. Such structure is disclosed in Patent Document 2 noted below.

On the other hand, displays with high colour fidelity, such as plasma display have been realized recently. Thus displays of a type such that a member-to-be-illuminated like lcd-panel is backlighted by a surface light source device are also comes to be required to have a high displaying quality, especially color displaying performance (color fidelity).

It is noted that “white LED” is a light emitting source generating light of a color like white by combining light of a blue LED with light of fluorescent substance. Now such a method of generating white light is called “white LED method” for the sake of convenience.

According to another known method, white light is generated by mixing light outputted from LED elements of R(red), G(green), B(blue) disposed so that number of LED element of each color is one or more. Now such a method of generating white light is called “LED light color mixing method” for the sake of convenience. It is known that LED light color mixing method is superior in color fidelity as compared with white LED method.

FIGS. 15 and 16 show an example of outlined structure of surface light source device employing LED light color mixing method. Such structure is disclosed in Patent Document 3 noted below.

Referring to FIGS. 15 and 16, surface light source device 102 includes two light guide plates 103, 104, a first group of LEDs and a second group of LEDs.

Light guide plates 103, 104 have one shape, being disposed so that the two are piled up vertically. Each group of LEDs are consist of three LEDs 105, 105, 105 of R, G and B, respectively. The first group of LEDs are disposed opposite to the right side face of upper side light guide plate 103 and the second group of LEDs are disposed opposite to the left side face of lower side light guide plate 104.

Light from the first group of LEDs 105 is color-mixed mainly within light guide plate 103, being emitted from emission face 107. Light from the second group of LEDs 105 is color-mixed mainly within light guide plate 104, being emitted from emission face 106 and then emitted from emission face 107 via light guide plate 103.

In such a way, light from the first and second groups of LEDs 105 becomes illumination output light emitted from emission face 107 of light guide plate 103 overall.

Patent Document 1; Tokkai-Hei 10-242513

Patent Document 2; Tokkai 2001-43721

Patent Document 3; Tokkai 2006-100102

However, surface light source device 102 shown in FIGS. 15 and 16 fails to be constituted under enough consideration for keeping positions of the point-like light sources (LEDs 105) employed as a primary light source stable with respect to incidence face 108.

Now referring to FIG. 17 showing a conventional surface light source device 112, reflection sheet 114 is disposed as to surround the employed point-like light source (LED 115). One end of reflection sheet 114 is fixed to an edge of emission face 116 of light guide plate 113 at the side of incidence face 121 with double-faced adhesive tape 122. In addition, the other end of reflection sheet 114 is fixed to an edge of back face 119 of reflection plate disposed along back face 117 of light guide plate 113 at the side of incidence face 121 with other double-faced adhesive tape 122.

If such a way of fixing is employed, a problem of abnormal emission caused by so-called “light leaking” is brought although position relation between the point-like light source (LED 115) and incidence face 121 is stabilized.

It is noted that “light leaking” is a phenomenon such that a part of primary light enters into light guide plate 113 via upper edge 123 or 124 of incidence face 121 of light guide plate 113. As known well, this phenomenon causes locally bright part (abnormal emission) to appear at a position in the vicinity of incidence face 1221 on emission face 116.

If such light leaking occurs in surface light source device 102 of a type shown in FIG. 15, light is emitted at a position in the vicinity of incidence face 108 on emission faces 103, 107 before being color-mixed. This brings unevenness in colour. It is noted that effective emission area (range capable of outputting illumination light) is reduced if double-sided adhesive tape 122 covers a large area, of emission face 116.

### DISCLOSURE OF INVENTION

An object of the present invention is to provide a surface light source device of a type having a light guide plate an incidence face (side end face) of which is supplied with primary light of one or more point-like light sources disposed sideways with respect to the light guide plate, wherein the surface light source device is improved as to allow light leaking, without reducing effective emission area, to be avoided from occurring and further as to allow point-like light source(s) (primary light source) to maintain position(s) with respect to the incidence face of the light guide plate.

Another object of the present invention is to provide a display allowing high-quality displaying by utilizing the above improved surface light source device.

In the first place, the present invention is applied to a surface light source device comprising a light guide plate; and a primary light source including at least one point-like light source. According to a feature of the present invention, said light guide plate has an incidence face provided by a side end face, a distal end face opposite to said incidence face, a rectangle-like emission face provided by a major face and a rectangle-like back face opposite to said emission face.

In addition, said incidence face is provided with at least one positioning-projection while a positioning-and-shading means is disposed between incidence face and said primary light source.

Further, said positioning-and-shading means is provided with at least one window allowing light emitted from said primary light source to pass toward said incidence face and a hole allowing said positioning-projection to be put into said hole.

Still further, dimension of said window along thickness-direction of said light guide plate is set as to be smaller than dimension of said emission face along thickness-direction of said light guide plate, thereby shading both an upper edge and a lower edge of said incidence face as to allow light emitted from said primary light source to be incident to neither said upper edge nor said lower edge.

A surface light source device in accordance with the present invention may further comprises a subsidiary light guide plate and a subsidiary primary light source including at least one point-like light source. In this case, said light guide plate is piled on said subsidiary light guide plate so that said back face is opposite to said subsidiary incidence face and said subsidiary incidence face is located at opposite side of said incidence face. Structure related to the subsidiary light guide plate is generally the same as that of the light guide plate. In other words, said subsidiary light guide plate has an subsidiary incidence face provided by a side end face, a subsidiary distal end face opposite to said subsidiary incidence face, a rectangle-like subsidiary emission face provided by a major face and a rectangle-like subsidiary back face opposite to said subsidiary emission face.

In addition, said subsidiary incidence face is provided with at least one subsidiary positioning-projection, and a subsidiary positioning-and-shading means is disposed between subsidiary incidence face and said subsidiary primary light source.

Further, said subsidiary positioning-and-shading means is provided with at least one subsidiary window allowing light emitted from said subsidiary primary light source to pass toward said subsidiary incidence face and a hole allowing said subsidiary positioning-projection to be put into said hole, and dimension of said subsidiary window along thickness-direction of said subsidiary light guide plate is set as to be smaller than dimension of said subsidiary emission face along thickness-direction of said subsidiary light guide plate, thereby shading both an upper edge and a lower edge of said subsidiary incidence face as to allow light emitted from said subsidiary primary light source to be incident to neither said upper edge nor said lower edge; and.

In a typical case, said positioning-and-shading means is provided by a side wall of a frame accommodating said light guide plate. Said subsidiary positioning-and-shading means may be provided by a side wall of a frame accommodating said light guide plate and said subsidiary light guide plate.

A plurality of said positioning-projections are preferably formed at locations along a length direction of said incidence face, and a plurality of said positioning-projections are formed at locations along a length direction of said incidence face.

In the next place, the present invention is applied to a display comprising a surface light source device and a displaying member illuminated by illumination light outputted from said surface light source device. According to a feature of the present invention, the surface light source device is any of the above surface light source devices.

According to the present invention, effects as follows are obtained.

(1) Blocked is light entrance into a light guide plate (and subsidiary light guide plate) via upper and lower edges of incidence face(s) of a light guide plate (and subsidiary light guide plate) by shading function of a positioning-and-shading means (and a subsidiary positioning-and-shading means). As a result, light leaking (local abnormal emission appearing on an emission face in the vicinity of an incidence face) is avoided from being caused.

(2) Position (relative position with respect to a primary light source) of light guide plate (and subsidiary light guide plate) is stabilized by positioning function of a positioning-and-shading means (and a subsidiary positioning-and-shading means). In addition, this positioning is performed without reducing effective emission area.

(3) A display having a displaying member illuminated by illumination light outputted from a surface light source device obtaining the above effects (1) and (2) gives a high-quality displaying performance.

It is noted that names like “subsidiary . . . ” are employed in the above “DISCLOSURE OF INVENTION” and “What is claimed is 1.

In EMBODIMENT described later, “subsidiary . . . ” is used for faces, members or others related to “first light guide plate 4”. On the other hand, names (light guide plate, primary light source, positioning menders and others) without heading “subsidiary” are used for faces, members or others related to second light guide plate 5′

General correspondence relation is as follows.
“light guide plate”=second light guide plate 5
“subsidiary light guide plate”=first light guide plate 4
“incidence face”=incidence face 6 of second light guide plate 5
“subsidiary incidence face”=incidence face 6 first light guide plate 5
“distal end face”=distal end face 15 of second light guide plate 5
“subsidiary distal end face 15”=distal end face 15 of first light guide plate
“emission face”=second light emission face 11 of guide plate 5
“subsidiary emission face”=emission face 17 of first light guide plate 5
“back face”=back face 18 of second light guide plate 5
“subsidiary back face”=back face 8 of first light guide plate 5
“primary light source”=second group of point—like light sources 14
“subsidiary primary light source”=first group of point-like light sources 14
“window”=window 31a allowing light from second group of point-like light sources 14
“subsidiary window”=window 31a allowing light from first group of point-like light sources 14
“positioning-projection”=positioning-projection 16 formed at incidence face 6 of second light guide plate 5
“subsidiary positioning-projection”=positioning-projection 16 formed at incidence face 6 of first light guide plate 4
“positioning-and-shading means”=means having functions of positioning and shading for second light guide plate 4, and being provided with “window” and a hole into which positioning projection 16 formed at incidence face 6 of second light guide plate 4 is fit.

subsidiary positioning-and-shading means”=means having functions of positioning and shading for first light guide plate 4, and being provided with a “subsidiary window” and a hole into which positioning projection 16 formed at incidence face 6 of first light guide plate 4; and being provided by side wall frame 3.

### BRIEF DESCRIPTION OF DRAWINGS

FIG. 1 illustrates a display of an embodiment in accordance with the present invention, giving a cross section view along A-A shown in FIG. 2;

FIG. 2 is a plan view of a surface light source device employed in the embodiment in accordance with the present invention, showing state in which a liquid crystal display panel is removed from the display shown in FIG. 1;

FIG. 3 is a diagramic cross section view of the display of the embodiment in accordance with the present invention, wherein a frame and others are omitted;

FIG. 4a is a diagramic partial plan view of the display shown in FIG. 2 for illustrating mounting state of a first light guide plate and LED package onto the frame, wherein some structure is omitted and a cross section of a part of the display is shown;

FIG. 4b is a view as viewed from B-direction in FIG. 4a;

FIG. 5a is a cross section view along C-C in FIG. 4a;

FIG. 5b is a view as viewed from F1-direction in FIG. 5a;

FIG. 6a is a cross section view along D-D in FIG. 4a;

FIG. 6b is a view as viewed from F2-direction in FIG. 6a;

FIG. 7 is a frontal view of spring means as viewed from E-direction in FIG. 6a;

FIG. 8 is a partial plan view of a light guide plate for illustrating a state of propagation of light from a LED;

FIG. 9 is a diagram showing emission brightness curves, being illustration corresponding to a cross section of a main part of a surface light source device in accordance with the present invention;

FIG. 10 is a diagramic view of a surface light source device for showing chromaticity measurement points in the vicinity of a point-like light source unit where color unevenness or coloring of emission which would cause a problem;

FIG. 11 is a diagram illustrating x-chromaticity values (i.e. chromaticity values expressed by x-chromaticity-coordinates on CIE 1931 XYZ color model) at the respective chromaticity measurement points shown in FIG. 10 for the surface light source device of the embodiment and, comparatively, for a surface light source device according to a prior art (See Patent Document 2);

FIG. 12 is a diagram illustrating y-chromaticity values (i.e. chromaticity values expressed by y-chromaticity-coordinates on CIE 1931 XYZ color model) at the respective chromaticity measurement points shown in FIG. 10 for the surface light source device of the embodiment and, comparatively, for a surface light source device according to a prior art (See Patent Document 2);

FIG. 13a is a partial perspective view of a frame employed in Modification 2 for the embodiment shown in FIG. 1, wherein a light guide plate and a point-like light source unit are omitted;

FIG. 13b is a cross section view (mounting state illustration) along G1-G1, showing a state in which a light guide plate and a point-like light source unit have been mounted to the frame shown in FIG. 13a;

FIG. 13c is a cross section view (mounting state illustration) along G2-G2, showing a state in which a light guide plate and a point-like light source unit have been mounted to the frame shown in FIG. 13a (mounting state illustration);

FIG. 13d is a cross section view (mounting state illustration) along G3-G3, showing a state in which a light guide plate and a point-like light source unit have been mounted to the frame shown in FIG. 13a (mounting state illustration);

FIG. 14 illustrates Modification 3 for the embodiment shown in FIG. 1, showing a state in which a LED package different from one employed in the embodiment shown in FIG. 1 has been mounted;

FIG. 15 is a diagramic cross section view of a surface light source device in accordance with a prior art;

FIG. 16 is a diagramic plan view of the surface light source device in accordance with the prior art; and,

FIG. 17 is a cross sectional diagram illustrating a state in which a light guide plate, a point-like light source and a reflection member of a conventional surface light source device have been positioned.

### EMBODIMENT

Hereafter Described in Detail is on an Embodiment in Accordance with the present invention by referring to the drawings. Although the embodiment employs two light guide plates (first light guide plate 4 and second light guide plate 5) disposed as to be piled, a single light guide plate may be employed instead. In a case employing a single light guide plate, first light guide plate 4 and elements related thereto (elements expressed like “subsidiary . . . ” in the above correspondence relation) are omitted.

(Outlined Structure of Surface Light Source Device and Display Including the Same)

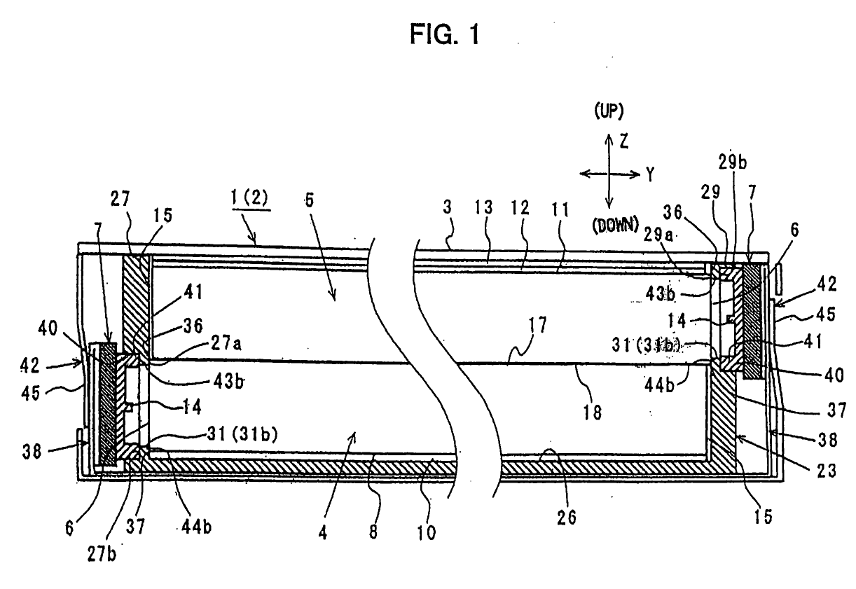

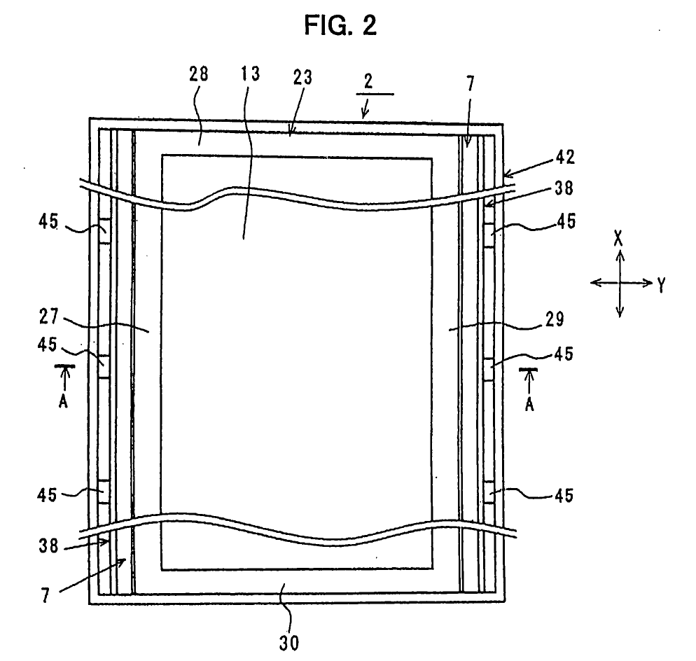

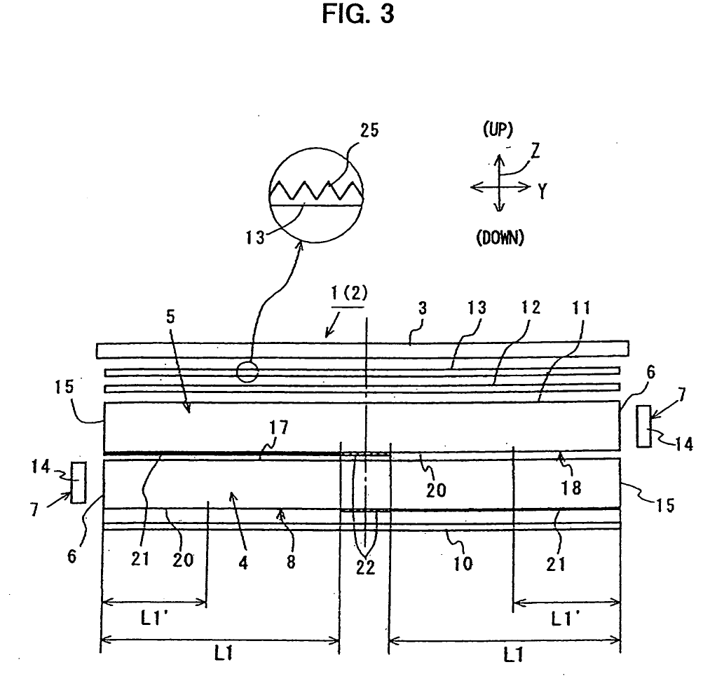

FIGS. 1 to 3 illustrate display 1 of the embodiment and surface light source device 2 included in display 1. FIG. 2 is a plan view of surface light source device 2. FIG. 1 is a cross section view along A-A shown in FIG. 2, wherein liquid crystal display panel 3 is added. FIG. 3 is a diagramic cross section view of display 1, wherein some parts thereof are omitted.

Liquid crystal display panel 3 (an example of member-to-be-illuminated) is backlighted by surface light source device 2. Surface light source device 2 comprises two light guide plates, namely, first light guide plate 4 and second light guide plate 5. Tease light guide plates 4, 5 are stacked. In FIG. 1, second light guide plate 5 is located above first light guide plate 4 (in this case, closer to liquid crystal display panel 3; in general cases, at an illumination light outputting side of surface light source device 2).

A side end face (minor face) of first light guide plate 4 provides incidence face (first incidence face) 6. The other side end face (minor face) of first light guide plate 4 provides distal end face (first distal end face) 5. On the other hand, a side end face (minor face) of second light guide plate 5 provides incidence face (second incidence face) 6. The other side end face (minor face) of second light guide plate 5 provides distal end face (second distal end face) 15.

Attention is to be paid to that incidence face 6 of first light guide plate 4 (first incidence face) and incidence face 6 of second light guide plate 5 (second incidence face) are located opposite to each other (at the left end of first light guide plate 4 and the right end of second light guide plate 5 in FIG. 1).

Referring to FIG. 1, an upper face (one major face) of first light guide plate 4 provides emission face (first emission face) 17 while lower face (the other major face) providing back face (first back face) 8. Needless to say, back face (first back face) 8 is located opposite emission face (first emission face) 17.

In a similar way, in FIG. 1, an upper face (one major face) of second light guide plate 5 provides emission face (second emission face) 11 while lower face (the other major face) providing back face (second back face) 18. Needless to say, back face (second back face) 18 is located opposite to emission face (second emission face) 11.

In addition, s thin low-refractive-index layer exists between emission face 17 of first light guide plate 4 and back face 18 of second light guide plate 5. It is noted that “ow-refractive-index layer” is a layer having refractive index lower than that of each of light guide plates 4, 5, being an air layer in a typical case. Further, reflection sheet 10 is disposed along back face 8 of first light guide plate 4 while first light control member 12 and second light control member 13 are disposed along emission face 11 of second light guide plate 5.

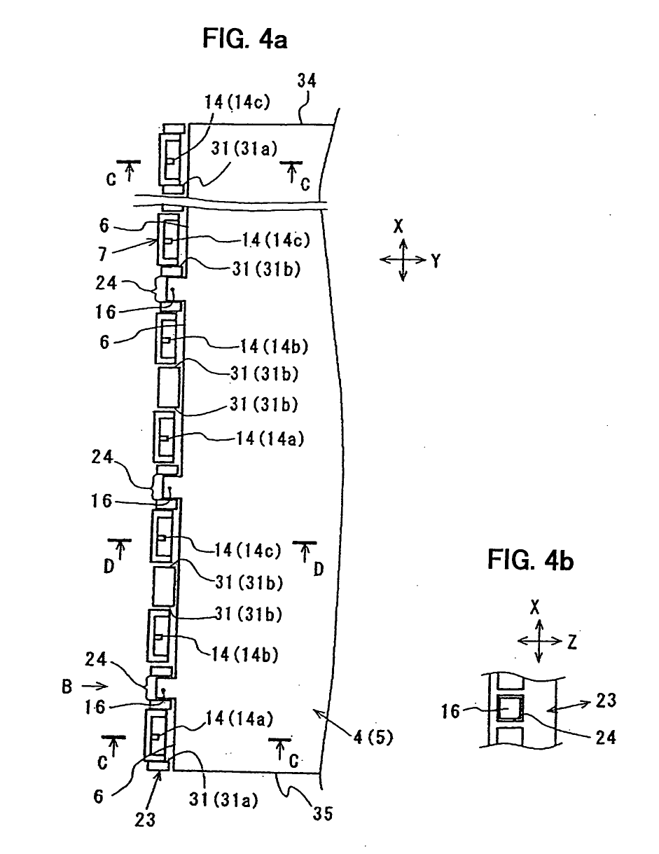

Point-like light source unit 7, 7 are disposed in the vicinity of incidence faces 6, 6 of first and second light guide plates 4, 5, respectively. As shown in FIG. 4a, each of point-like light source units 7, 7 is provided with LEDs (point-like light sources) 14 (14a, 14b, 14c). Emission color of LED 14a is R (red), that of LED 14b being G (green) and that of LED 14c being B (blue).

As known well, white light is obtained by colour-mixing these three primary colours R, G, B. For each of point-like light source units 7, 7, LEDs 14a, 14b, 14c are arranged in a line along a longitudinal direction of incidence faces 6, 6 (in X-direction in FIGS. 2, 4a and 4b).

It is noted that a point-like light source group (LEDs 14a, 14b, 14c) supplying primary light toward incidence face 6 of first light guide plate 4 is called first point-like light source group (subsidiary) point-like light source) and point-like light source group (LEDs 14a, 14b, 14c) supplying primary light toward incidence face 6 of second light guide plate 5 is called second point-like light source group (primary light source).

It is noted that the two sets of (EDs 14a, 14b, 14c) employed in the embodiment for each point-like light source group, as shown in FIG. 4a. give merely an example. In general, one or more sets of point-like light source groups are arranged. In addition, emission colour combination of each point-like light source group is typically R, G B, allowing other emission colour combination. Number of point-like light sources belonging to one point-like light source group is typically three, allowing two, four, five or more.

For example, in a case where three sets of point-like light source groups are arranged, a set consisting of (one R, one G, two Bs), another set consisting of (one R, two Gs, one B) and still another set consisting of (two Rs, one G, one B) may be employed. Still further saying, various variation regarding emission colour and number of point-like light sources may be adopted.

### (First Light Guide Plate and Second Light Guide Plate)

First light guide plate 4 and second light guide plate 5 are made of a light permeable material such as polymethyl methacrylate (PMMA), polycarbonate (PC) or cycloolefin type resin. Each of first light guide plate 4 and second light guide plate 5 has a “generally rectangular (square)” plan shape, as shown in FIGS. 1, 4a, and 4b.

Incidence faces 6, 6 of first light guide plate 4 and second light guide plate 5 a plurality of positioning-projections 16, respectively. In other words, first light guide plate 4 and second light guide plate 5 have rectangular plan shapes of substantially the same size and shape, if positioning-projections 16 are removed. In addition, Each of first light guide plate 4 and second light guide plate 5 extends with uniform from thickness from each incidence face 6 to distal end face (another side face) 15.

First light guide plate 4 has emission restraint region (first emission restraint region) 20, emission promotion region (first emission promotion region) 21 and emission gradually-increasing region (first emission gradually-increasing region) 22 bridging these regions. In a similar way, second light guide plate 5 also has emission restraint region (second emission restraint region) 20, emission promotion region (second emission promotion region) 21 and emission gradually-increasing region (second emission gradually-increasing region) 22 bridging these regions.

Emission restraint region 20 of either of light guide plates 4 and 5 is formed in the vicinity of incidence face 6 and emission promotion region 21 of either of light guide plates 4 and 5 is formed far from incidence face 6. Emission gradually-increasing region 22 extends between both regions 20 and 21. Saying more concretely, back face 8, 8 of either of first light guide plate 4 and second light guide plate 5,

In each of first light guide plate 4 and second light guide plate 5, back face 8 or 18 is formed flat and smooth in a range of predetermined dimension (L1) from each incidence face 6 toward each distal end face 15, 15. This restrain intensively emission faces 17, 11 from emitting light in the range. In addition, the range provides emission restraint region.

It is noted that predetermined dimension L1 is set as “distance from incidence face 6 enough to cause light from LEDs 14 of R, G, B (14a to 14c) is sufficiently colour-mixed and become substantially white light”. Accordingly, L1 is preferably larger than color-mixing beginning distance L1′ (L1>L1′). It is noted that color-mixing beginning distance L1′ is “distance from incidence face 6 enough to cause-light from LEDs 14 of R, G, B (14a to 14c) substantially starts colour-mixing”.

If distance from incidence face 6, 6 of each of first light guide plate 4 and second light guide plate 5 exceeds L1′ mentioned above, colour-mixing progresses and degree of with light generating increases. Colour-mixing beginning distance L1′ can be determined, for example, as follows.

Light from each LED 14a, 14b, 14c . . . enters into light guide plate 4 or 5 through incidence face 6, becoming inner propagation light respectively. Now is provided that angular expansion of each inner propagation light in a plane parallel with emission face 11 is θ. In addition, provided is that arraying the respective pitches of LEDs of the same emission color are Pa, Pb, Pc. Distance between 14a-14a gives Pa, distance between 14b-14b gives Pb, and distance between 14c-14c gives Pc,

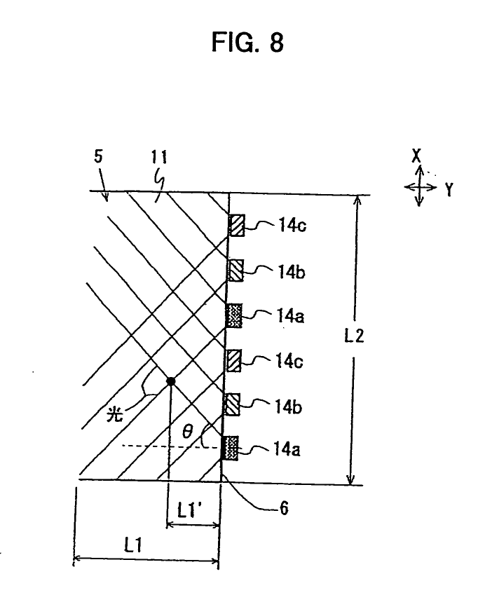

Under such situation, colour-mixing beginning distance L1′ can be defined as follow (See FIG. 8).

L1′ = P/(2 · tan θ )
; where P is a value of the maximum of Pa, Pb, Pc.
Namely,
P = max[Pa, Pb, Pc]
If Pa = Pb = Pc, the following is obtained ((See FIG.8).
L1′ = Pa/(2 · tan θ ) = Pb/(2 · tan θ ) = Pc/(2 · tan θ)

Thus, if any means for making angle θ large is applied to incidence face 6 or the vicinity thereof, relatively small L1′ can be employed, as compared with cases where such means is not applied.

It is preferable, however, that L1>L1′ is satisfied, as already mentioned, because L1′ is distance from incidence face 6 required for beginning of mixing of light of the same colour. It is noted that predetermined dimension L1 preferably has a valued adjusted as to be the optimum one under consideration of dimensions of first and second light guide plates 4, 5 and emission characteristics of LEDs 14a to 14c.

Now is provided that incidence face 6 of each of first light guide plate 4 and second light guide plate 5 has a dimension L2 along a longitudinal direction (X-direction), as shown in FIG. 8. If so provided, emission restraint regions 20, 20 of first light guide plate 4 and second light guide plate 5 are regions having area of L1)×(L2), respectively. Thus regions each having area of L1′)×(L2) can be regarded as colour-mixing regions.

Now is direction emission promotion region 21. First, emission promotion region (first emission promotion region) 21 of first light guide plate 4 is formed as to be overlapped with emission restraint region (second emission restraint region) 20 of second light guide plate 5. On the other hand, emission promotion region (second emission promotion region) 21 of second light guide plate 5 is formed as to be overlapped with emission restraint region (first emission restraint region) 20 of first light guide plate 4. In other words, respective ranges within predetermined dimension L1 from each distal end faces 15, 15 provide respective emission promotion regions 21, 21 for respective light guide plates 4, 5.

Emission region means is applied to areas in back faces 8, 18 corresponding to emission promotion region 21 in order to promote emission from emission faces 17, 11. Examples of employable emission region means are matted surface, numerous fine prismatic projection rows, blast-proceed surface, fine projections like pyramids or cones, rough surface with fine recesses and white-ink-printed surface. In general, any optional means may be employed so far as emission from emission faces 11, 17 is promoted.

Emission gradually-increasing regions 22, 22 are formed between respective emission restraint regions 20 and emission promotion regions 21 for respective light guide plates 4,5. Thus the following relation is satisfied for predetermined dimension L1.

2L1<distance from emission face 6 to distal end face 15 (total length of each light guide plate 4. 5).

Emission gradually-increasing region (firs emission gradually-increasing region) 22 of first light guide plate 4 and emission gradually-increasing region (second emission gradually-increasing region) 22 of second light guide plate 5 are overlapped with each other in a direction of thickness of first light guide plate 4 and second light guide plate 5.

It is noted that the above direction of thickness of first light guide plate 4 and second light guide plate 5 is called simply “thickness-direction” hereafter.

Each emission gradually-increasing region 22 is a region (bridging region) bridging each emission restraint region 20 and each emission promotion region 21. Respective emission gradually-increasing regions of light guide plates 4, 5 have emission promotion ability which increases according to distance from incidence face 6. In addition, each of light guide plates 4, 5 is formed as to avoid boundary between emission gradually-increasing region 22 and emission restraint region 20 from having discontinuous changing of emission promotion ability.

In a similar way, each of light guide plates 4, 5 avoids boundary between emission gradually-increasing region 22 and emission promotion region 21 from having discontinuous changing of emission promotion ability.

Such a gradient of emission promotion ability may be given to each emission gradually-increasing region 22 by changing (increasing) formation density of above-mentioned emission promotion means smoothly with distance from incidence face 6. It is noted that emission promotion means applied to each emission promotion region 21, 21 and that applied to each emission gradually-increasing region 22, 22 may be different from each other unless neither uncomfortable visual feeling nor unevenness in brightness as observed from above the surface light source device 2.

Next, now described are positioning-projections 16.

Rectangle-rod-like positioning-projections 16 are formed at an appropriate interval at portions between LEDs 14, 14 adjacent to each other on each incidence face 6 of each of light guide plates 4, 5 as shown in FIG. 4a. These positioning-projections 16 can be fit into light-guide-plate-positioning-holes 24 formed on frame 23. Therefore, first light guide plate 4 and second light guide plate 5 is positioned not only regarding position in X-direction but also regarding Z-direction (up-down direction). As a result, both light guide plates 4, 5 is avoided from moving or allowed to move only by an extremely small distance in Z/direction. This extremely small distance is substantially equal to each gap formed between positioning-projection 16 and light-guide-plate-positioning-hole 24.

(First Light Control Member and Second Light Control Member)

The embodiment employs a light diffusion sheet as first light control member 12 and a prism sheet as second light control member 13. Structure, constituting material and basic functions of these optical members are well-known, being described very simply.

First light control member (light diffusion sheet) 12 is a sheet formed of a light permeable resin, having at least one roughened face. Light (here, white light) emitted from emission face 11 of second light guide plate 5 is diffused by first light control member 12, then being incident to second light control member 13. Such diffusion prevents emission promotion region 21 formed on each of light guide plates 4 and 5 from being conspicuous. It is noted that first light control member 12 has generally the same shape and dimension as those of emission face 11.

Next, the prism sheet disposed as second light control member 13 in the embodiment has an outer face (directed to liquid crystal display panel 3) on which a great number of prismatic projections 25 are formed (See FIG. 3). Prismatic projections 25 runs in a direction generally parallel to incidence face 6, 6 of each of light guide plates 2 and 5.

Second light control member 13 has a well-known light proceeding direction redirecting function by which proceeding directions of light diffused by first light control member 12 are gathered as to be near to a frontal direction and to be directed to liquid crystal display panel 3. Thus liquid crystal display panel 3 provides an increased brightness of displaying.

(Frame and Diaphragm Means)

As shown in FIGS. 1, 2, 4a, 4b to 6a, 6b, display 1 comprises box-like frame 23 opening largely toward upside. Frame 23 is formed of a resin material (such as PC), being provided with bottom plate 26. Piled up on bottom plate 26 are various members (reflection sheet 10, first light guide plate 4. second light guide plate 5, first light control member 12 and second light control member 13) for being accommodated. side Walls 27 to 30 standing up from bottom plate 26 restrain the various members accommodated inside from shifting (moving) along X-Y plane (parallel with a bottom plate plane).

In addition, side walls 27, 29 of frame 23 are opposite to incidence faces 6,6 of light guide plates 4, 5 respectively, being provided with windows 31 allowing light from LEDs 14 to passes through. Functions of these windows 31 are described below by seeing relation between first light guide plate 4 and frame 23.

As mentioned previously, groups of LEDs 14 are arrayed along the longitudinal direction of the respective incidence faces 6, 6 (i.e. X-direction in FIGS. 4a, 4b). Corresponding to this, a plurality of windows 31 are formed. These windows 31 can be classified into windows corresponding to point-like light sources (14a, 14c) located at both end portions and the other windows. For the sake of convenience, the formers are denoted by reference numeral 30 (31a) and the latter is denoted by reference numeral 30 (31b).

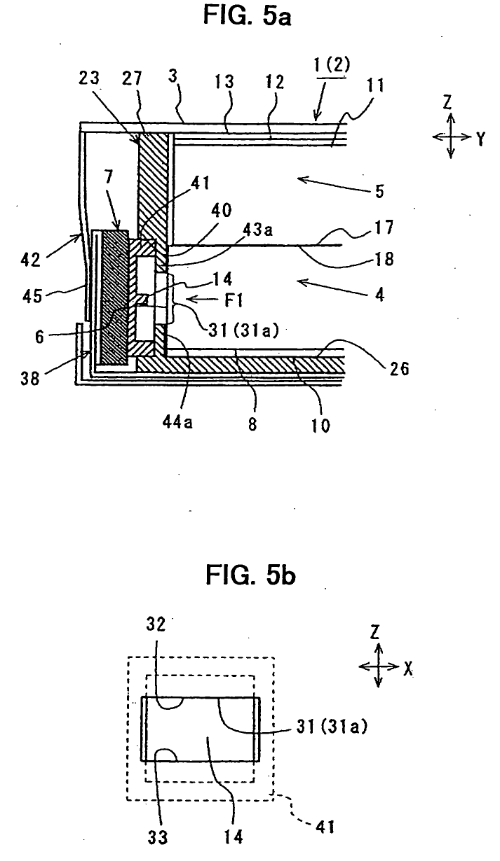

Each window 30 (31a) has “vertical length” smaller than “vertical length” of each window 30 (31b). It is noted that “vertical length” is opening dimension along thickness direction. Namely, each window 30 (31a) has upper and lower end portions 32, 33 each having a predetermined length as shown in FIG. 5b for defining an opening. Accordingly, light from LEDs 14 (located at both end portions) corresponding to each window 30 (31a) is subject to angularly narrowed expansion regarding thickness direction as compared with light from each of the other LEDs corresponding to each window 30 (31b), causing incidence light quantity to incidence face 6 to be reduced (limited). In this sense, windows 30 (31s) can be regarded as “diaphragm means (incidence light quantity limiting means)”.

The reason why such diaphragm means is arranged as to correspond to LEDs located at both end portions is that intensity of reflection light generated by light LEDs located at both end portions is to be reduced. That is, light from LEDs located at both end portions is more likely to be incident to side faces 34, 35 vertical to incidence face 6 after inner propagating within first light guide plate 4 as compared with light from the other LEDs. Such incident light becomes transmitting light and inner-reflection light. A large part of the transmitting light becomes again inner propagation light after being reflected by an inner surface of frame 23. Light paths made on the way of such processes, pass emission promotion region 21 doubtlessly, promoting emission on passing there. Such emission is apt to occur, in particular, in the vicinity of side faces 34, 35. It is noted that light emitted in such a way is likely to undergo insufficient emission colour-mixing with other LEDs, causing coloured emission or color unevenness to be induced. In other words, coloured emission or color unevenness tends to emerge in the vicinity of side faces 34, 35.

The above-described diaphragm means, namely, windows 30 (31a), can be effected as to restrain such phenomena. That is, quantity of the light which can be incident to incidence face 6 from LEDs located at both end portions. As a result, color unevenness and coloured emission are avoided from appearing. It is noted that “lateral dimension” (dimension along X-direction in FIGS. 4a, 4b) of each window 30 (31a) providing diaphragm means can be adjusted. Any way, opening area Sa of each window 30 (31a) is smaller than opening area Sb of each window 30 (31b). The optimum opening area ration Sa/Sb is preferably determined under consideration of various factors such as emission characteristics of LEDs, reflection characteristics of frame 23.

In addition, relation between first light guide plate 4 and windows 30 (31b), located at other than both end portions, of frame 231 is as follows,

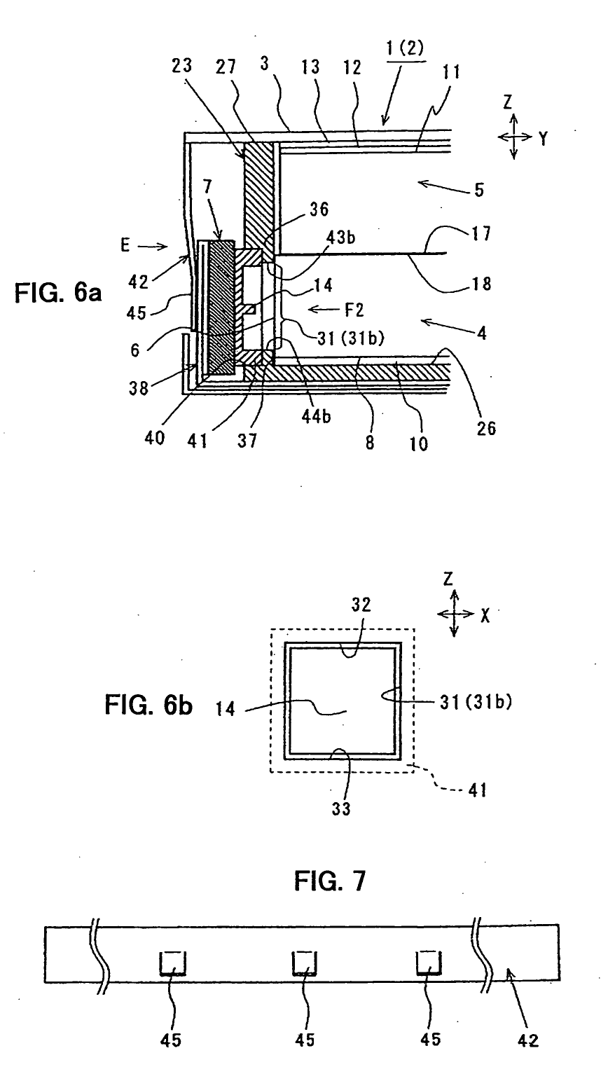

As shown in FIGS. 1 and 6a, frame 23 covers edges upper and lower side along thickness direction (Z-direction) for first light guide plate 4 so as to avoid light from LEDs 14 (located at other than both end portions) from entering into first light guide plate 4 via edge 36 of the upper side or edge 37 of the lower side. Dimension of covering of each of edges 35, 37 by frame 23 is determined under consideration of shakable dimension of positioning-projections 16 of first light guide plate 4 within light-guide-plate-positioning-holes 24 of frame 23.

Thus light from LEDs 14 is avoided from entering into first light guide plate 4 via upper edge 36 or lower edge 37 even if first light guide plate 4 accommodated in frame 23 moves in a vertical direction (±Z-direction).

Further in the embodiment, since positioning-projections 16 of incidence face 6 of first light guide plate 4 is fit into light-guide-plate-positioning-holes 24 of frame 23, performed are not only positioning regarding thickness direction (Z-direction) but also positioning regarding longitudinal direction of incidence face 6 (X-direction), resulting in limited shaking movements. Therefore, light from LEDs 14 (located at other than both end portions) is avoided from entering into first light guide plate 4 via edge 36 of the upper side or edge 37 of the lower side even under using circumstance such that vibration or impact is effected.

As known well, “light entering into a light guide plate via such edges” can cause abnormal emission to occur locally. The emission is free from such local abnormal emission.

The above-described relation among frame 23, first light guide plate 4, respective windows 31 and others exists among frame 23, second light guide plate 5, respective windows 31 and others, in a similar manner. Therefore, repeated description is omitted.

Now is added some description on frame 23 employed in the embodiment. Frame 23 is formed of black resin material. This causes light from LEDs 14 to be avoided from entering into light guide plates 4, 5 through portions other than incidence faces 6, 6 by light absorbing. In addition, this shading function assists functions of diaphragm means.

It is noted, however, that materials which have any shading function and any colour other than black may be employed depending on emission characteristics of LEDs 14 and others.

(State of LED-Package Mounting to Frame)

As shown in FIGS. 1, 5a and 6a, point-like light source units 7 are LED-packages 41 fit into package-engaging-recesses 40 formed on frame 23. LED-packages 41 are pressed to first light guide plate 4 or second light guide plate 5 together with thermal conductive sheets 38 via thermal conductive sheets 38 by means of spring means 2.

Thus LED-packages 41 are prevented from escaping from package-engaging-recesses 40 of frame 23, being secured at certain positions.

It is noted that LED-packages 41 pressed by spring means 42 push thin upper edge vicinity portions 43a, 43b and thin lower edge vicinity portions 44a, 44b of windows 31 of frame 23 to incidence face 6 of first light guide plate 4 or second light guide plate 5.

FIG. 7 is a frontal view of spring means 42 as viewed from E-direction in FIG. 6a. As shown in FIG. 7, spring means 42 is produced by applying sheeting processes to a plate-like elastic member. Spring means 42 evenly presses a plurality of portions (a plurality of portions corresponding to LED-packages 41 in the embodiment) of point-like light source unit(s) 7 securing a plurality of LED groups as being unified.

Spring means 42 include elastic contacting elements 45 pressing point-like light source units 7. Elastic contacting elements 45 are formed by partially cut-and-raising plate-like side walls of spring means 42. It is noted that thermal conductive sheets 38 may be omitted in the embodiment. If so, LED-packages 41 may be fit into package-engaging-recesses 40 so that point-like light source units 7 may be directly pressed by elastic contacting elements 45.

### (Effects and Advantages of the Embodiment)

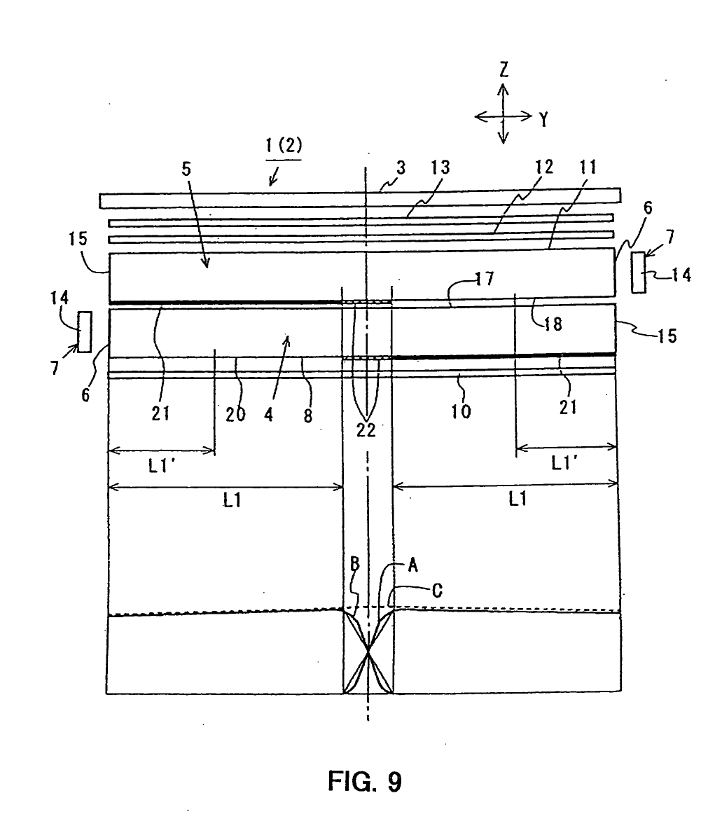

FIG. 9 is a diagram showing an emission brightness curve (solid line A=first pattern) under the following lighting condition 1, an emission brightness curve (solid line B=second pattern) under the following lighting condition 2 and an emission brightness curve (solid line C=third pattern) under the following lighting condition 3 for surface light source device 2, being illustration corresponding to a cross section of surface light source device 2.

Lighting condition 1; Lighted on are only respective LEDs 14 (14a to 14c) belonging to point-like light source unit 7 close to incidence face 6 of first light guide plate 4.

Lighting condition 2; Lighted on are only respective LEDs 14 (14a to 14c) belonging to point-like light source unit 7 close to incidence face 6 of second light guide plate 5.

Lighting condition 3; Lighted on are respective LEDs 14 (14a to 14c) belonging to respective point-like light source units 7 close to incidence faces 6 of first and second light guide plates 4 and 5.

The followings are understood from FIG. 9.
(a) Seeing the first pattern, emission restraint region (first emission restraint region) 20 of first light guide plate 4 provides emission little.
(b) Seeing the second pattern, emission restraint region (second emission restraint region) 20 of second light guide plate 5 provides emission little.
(c) Seeing the first pattern, emission promotion region (first emission promotion region) 21 of first light guide plate 4 provides generally even emission. Seeing in detail, found is an extremely gentle reduction in brightness toward distal end face 15.
(d) Seeing the second pattern, emission promotion region (second emission promotion region) 21 of second light guide plate 5 provides generally even emission. Seeing in detail, found is an extremely gentle reduction in brightness toward distal end face 15.
(e) Seeing the first pattern, emission gradually-increasing region (first emission gradually-increasing region) 22 of first light guide plate 4 gives brightness increasing as approaching distal end face 15.
(f) Seeing the second pattern, emission gradually-increasing region (second emission gradually-increasing region) 22 of second light guide plate 5 gives brightness increasing as approaching distal end face (g) Seeing the third pattern, generally constant emission occurs overall. Seeing in detail, found are extremely gentle reductions in brightness from a center portion toward distal end face 15 of first light guide plate 4 and distal end face 15 of second light guide plate 5.

Judging from the above matters, surface light source device 2 of the embodiment provides highly even brightness.

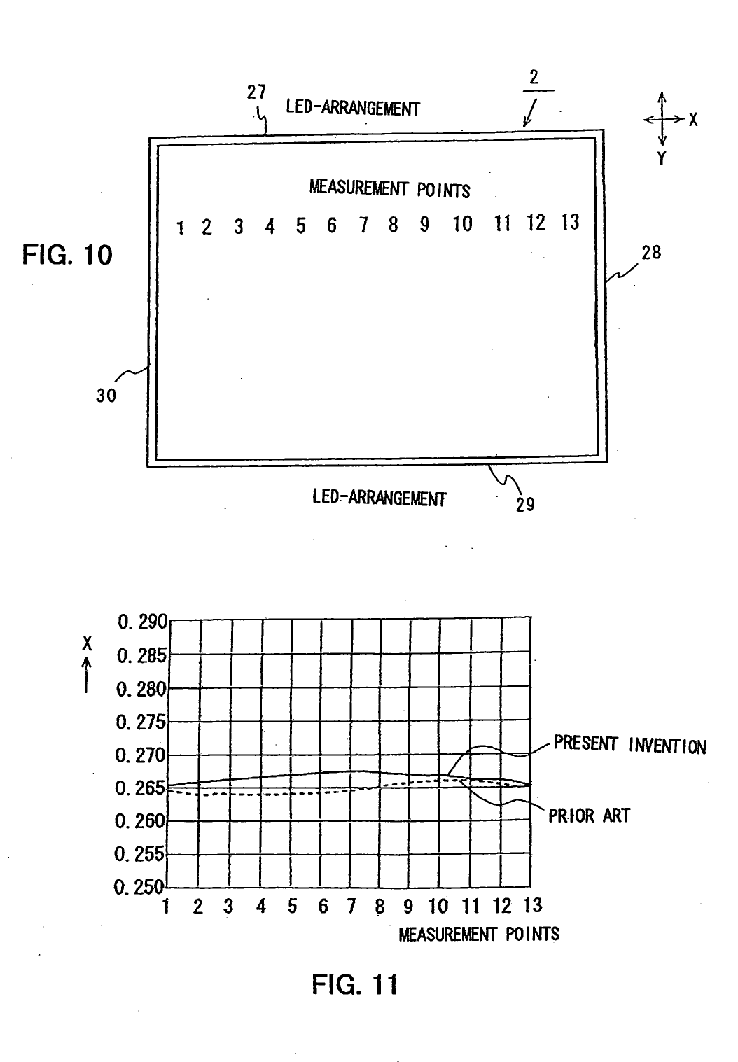

Next described is colour uniformity of illumination output light of surface light source device 2 in accordance with the embodiment. FIG. 10 is a diagramic plan view of surface light source device 2. Shown in the illustration are chromaticity measurement points (1 to 13) for emission, the chromaticity measurement points being located in the vicinity of point-like light source units (in a range within about 20 mm from incidence face 6 of surface light source device 2 of 8 inch size).

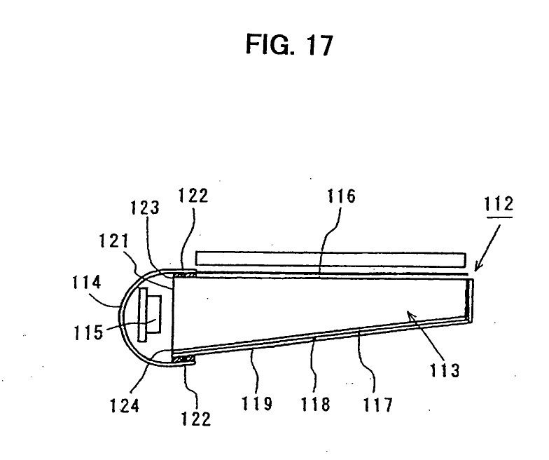

FIG. 11 is a diagram illustrating x-chromaticity values obtained at the respective chromaticity measurement points (1 to 13) shown in FIG. 10 for surface light source device 2 of the embodiment and, comparatively, for surface light source device according 102 of a prior art (See FIG. 17).

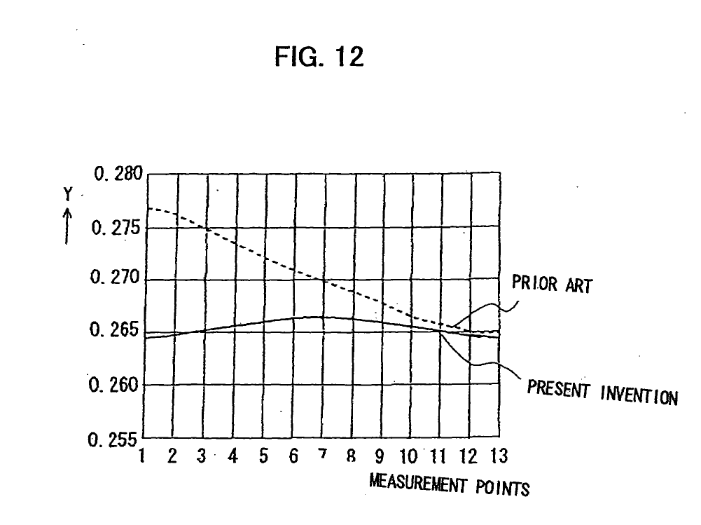

In addition, FIG. 12 is a diagram illustrating Y-chromaticity values obtained at the SAME respective chromaticity measurement points (1 to 13) for surface light source device 2 of the embodiment and, comparatively, for surface light source device according 102 of a prior art (See FIG. 17). It is to be noted that surface light source device 102 of a prior art is not provided with diaphragm means for adjusting light incidence to the light guide plate from both end LEDs 14.

In addition, “x-chromaticity value,” is chromaticity value expressed by x-chromaticity-coordinate on CIE 1931 XYZ color model. in a similar way, “y-chromaticity value” is chromaticity value expressed by y-chromaticity-coordinate on CIE 1931 XYZ color model.

As shown these figures, surface light source device 2 of the embodiment (See curves denoted by PRESENT INVENTION in FIGS. 11, 12) shows, roughly saying, symmetry with respect to center measurement point 7. Further saying, unevenness in x-chromaticity values and y-chromaticity values a found between center measurement point 7 and both end measurement points 1, 13 is very small

To the contrary, conventional surface light source device 102 (See curves denoted by PRIOR ART in FIGS. 11, 12) fails to show symmetry with respect to center measurement point 7. Besides, unevenness in chromaticity values is large.

As described above, the embodiment provides illumination light with evenness in chromaticity values higher than that of the prior art. It is a significant merit that vicinity of side faces 34, 35 of light guide plates 4, 5 has reduced colour unevenness and restrained colouring. Further, this merit makes high quality color displaying easy.

It is noted that the present invention is not limited by the embodiment, allowing modifications as follows.

(Modification 1)

Below noted are examples of means employable instead of diaphragm means which is provided by limiting opening area of windows 31 (31a) of frame 23.

(i) Windows 31 of frame 23 may have the same opening area under a condition such that shading members (such as shading films or shading tapes), not shown, may be applied to emission surfaces of both end LEDs 14, 14 for shading a predetermined area of the surfaces of both end LEDs 14, 14. That is, shading members may used as shading means.

(ii) Shading members may be applied to portions, opposite to both end LEDs 14, 14, of incidence faces 6 of first light guide plate 4 and second light guide plate 5.

(iii) Windows 31 of frame 23 may have the same opening area under a condition such that spacers, not shown, each having diaphragm opening with opening areas each smaller than opening area of window 31 of frame 23 may be disposed between both end LEDs 14, 14 and first and second light guide plate 4,5.

(iv) Instead of the spacers, light transmissivity adjusting sheets (such as diffusion sheets) may be disposed as diaphragm means.

(v) Windows 31 of frame 23 may have the same opening area under a condition such that shading ink may be applied to emission surfaces of both end LEDs 14, 14 for providing shading means.

(vi) Windows 31 of frame 23 may have the same opening area under a condition such that shading ink may be applied to part areas of incidences face 6 at locations corresponding to both end LEDs 14, 14 for providing shading means.

(Modification 2)

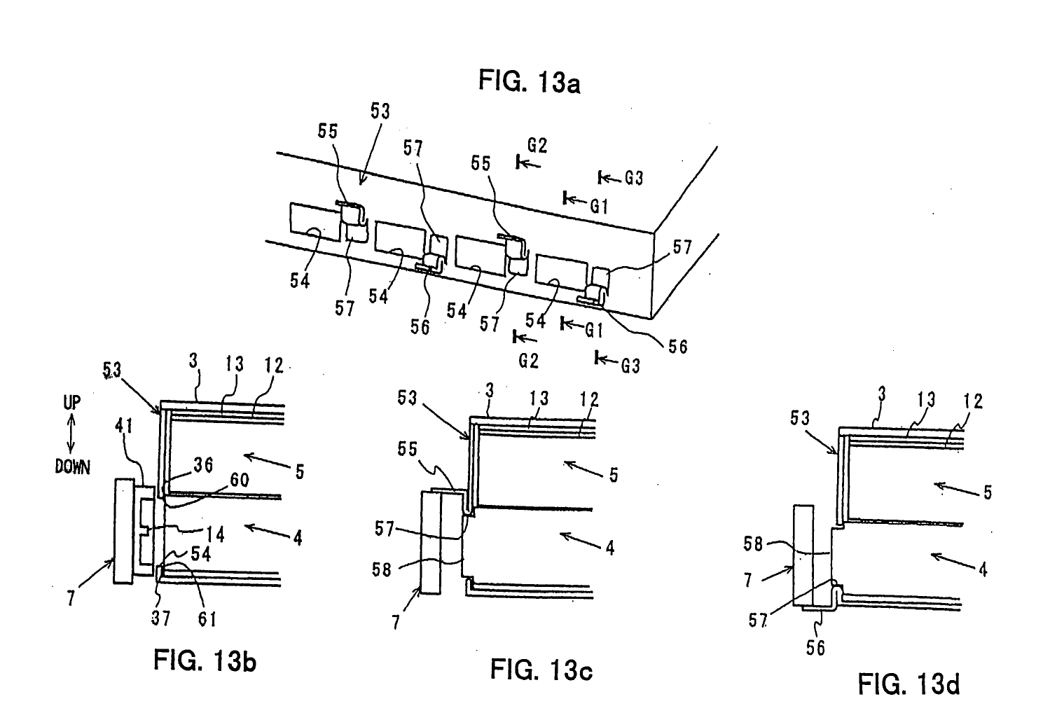

FIGS. 13a to 13d illustrate Modification 2 of the above embodiment. This modification employs frame 53 formed of a metal plate instead of frame 23 formed of a resin material. As shown in FIGS. 13a to 13d, Frame 53 has windows 54 which are formed at portions opposite to LED-packages 41 of point-like light source units 7. Between windows 54, 54, nails 55, 56 are arranged for securing point-like light source units between LED-packages 41, 41.

First nails 55 abutting an upper portion of point-like light source units 7 and second nails 56 abutting a lower portion of point-like light source units 7 are arranged alternately.

In addition, frame 23 uses holes provided by first and second nails 55, 56 as light-guide-plate-positioning-holes 57 into which positioning-projections 58 of first light guide plate 4 and second light guide plate 5 are engaged.

Further, each window 54 of frame 53 has upper edge vicinity 60 and lower edge vicinity 61 which shade upper edge 36 and lower edge 37 of each of each incidence face 6 of light guide plates 4, 5 as to avoid light of LEDs 14 from being incident thereto.

In this modification, it is preferable that frame 53 is formed of a highly reflective metal or has a frame inner surface, on which first light guide plate 4 and second light guide plate 5 are put and to which any means for heightening light reflectivity. If so, light utilization efficiency is heightened and more bright and uniform white light illumination is provided.

(Modification 3)

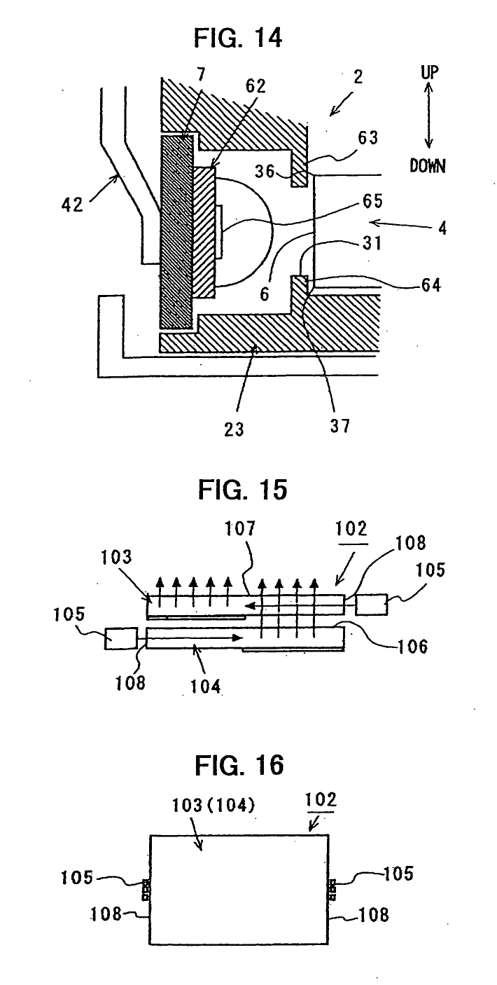

FIG. 14 illustrates a state in which LED packages 62 different from LED-packages 41 of the embodiment. Each LED package 62 employed in this modification has a hemisphere emission surface in contrast with each LED-package 41, employed in the embodiment, having a flat emission surface.

Such LED-packages 62 are not able to push thin portions around windows 31 toward the sides of first light guide plate 4 and second light guide plate 5. Therefore, first light guide plate 4 and second light guide plate 5 are pressed to the side of windows 31 of frame 23 with LED-packages 62. Alternatively, opening areas of windows are determined under consideration of gaps between frame 23 and first and second light guide plates 4, 5.

Upper edges 36 and lower edges 37 of incidence faces 6 of first light guide plate 4 and second light guide plate 5 are prevented from receiving light from LEDs 14. Surface light source devices 2 each employing LED-packages 62 in accordance with this modification have merits similar to those of the embodiment.

(Other Modifications)

Other modifications are employable as follows.

(I) Second light control member 13 may be a prism sheet directed downward (prismatic projections are formed as to correspond to second light control member 12). In addition, on this downward prism sheet, and the prism sheet having prismatic projections running in a described vertical to the longitudinal direction of incidence face 6 may be disposed as a third light control member.

In general, numbers of prism sheets and running directions and shapes of prismatic projections are can be determined optionally in designing. Regarding light diffusion sheet employed as third light control member, no particular limitation of numbers is not required.

A light diffusion sheet may be disposed outside of second light control member 13.

(II) In general, kinds and numbers of light control members disposed on emission face 11 are not limited specifically. For example, light control members disposed on emission face 11 may include a polarization separating sheet. It is noted that a polarization separating sheet is a well-known optical member for utilizing only a required polarization component as emission.

(IV) Emission promotion means may be applied to emission faces 17, 11 instead of portions other than back faces 8, 18, or in addition to back faces 8, 18.

(V) The above embodiment employs point-like light source unit 7 each having a plurality of sets of LEDs 14a, 14b, 14c of R, G, B. However, this does not limit the scope of the present invention. For example, LEDs of emission colors other than R, G, B, as required.

(VI) The present invention allows each group of point-like light sources to have somewhat unevenness in emission color (emitting roughly white light). Reflection sheet 10 may be omitted. In particular, if frame 23 has a light reflective bottom inner face, omitting of reflection sheet 10 brings no problem.

(VII) Positioning-projections 16 of first light guide plate 4 and second light guide plate 5 may be shaped like round rods. In general, light-guide-plate-positioning-holes 24 may be round holes allowing positioning-projections 16 to be fit into.

(VII) Thickness of light guide plates 4, 5 may decrease with approaching each distal end face 15 from each incidence face 6.

(IX) Displaying members (member-to-be-illuminated) irradiated by surface light source devices 2 may be other than LCD-panel 3, for example, may be transmitting plate on which an image is illustrated.

(X) In the specification and drawings, “up” and “down” are used only for the sake of description, corresponding to Z-direction in FIG. 1. It is to be noted that, for example, if surface light source device 2 is used under an oblique installing condition, Z-direction is also inclined.

What is claimed is:

1. A surface light source device comprising:
a light guide plate; and
a primary light source including at least one point-like light source, wherein
said light guide plate has an incidence face provided by a side end face, a distal end face opposite to said incidence face, a rectangle-like emission face provided by a major face and a rectangle-like back face opposite to said emission face,
said incidence face being provided with at least one positioning-projection;
a positioning-and-shading means being disposed between incidence face and said primary light source;
said positioning-and-shading means being provided with at least one window allowing light emitted from said primary light source to pass toward said incidence face and a hole allowing said positioning-projection to be put into said hole; and
dimension of said window along thickness-direction of said light guide plate being set as to be smaller than dimension of said emission face along thickness-direction of said light guide plate, thereby shading both an upper edge and a lower edge of said incidence face as to allow light emitted from said primary light source to be incident to neither said upper edge nor said lower edge.

2. A surface light source device in accordance with claim 1, wherein said surface light source device further comprises a subsidiary light guide plate and a subsidiary primary light source including at least one point-like light source,
said subsidiary light guide plate having an subsidiary incidence face provided by a side end face, a subsidiary distal end face opposite to said subsidiary incidence face, a rectangle-like subsidiary emission face provided by a major face and a rectangle-like subsidiary back face opposite to said subsidiary emission face;
said subsidiary incidence face being provided with at least one subsidiary positioning-projection;
a subsidiary positioning-and-shading means being disposed between subsidiary incidence face and said subsidiary primary light source;
said subsidiary positioning-and-shading means being provided with at least one subsidiary window allowing light emitted from said subsidiary primary light source to pass toward said subsidiary incidence face and a hole allowing said subsidiary positioning-projection to be put into said hole; and
dimension of said subsidiary window along thickness-direction of said subsidiary light guide plate being set as to be smaller than dimension of said subsidiary emission face along thickness-direction of said subsidiary light guide plate, thereby shading both an upper edge and a lower edge of said subsidiary incidence face as to allow light emitted from said subsidiary primary light source to be incident to neither said upper edge nor said lower edge; and,
said light guide plate being piled on said subsidiary light guide plate so that said back face extends opposite to said subsidiary emission face and said subsidiary incidence face is located at opposite side of said incidence face.

3. A surface light source device in accordance with claim 1, wherein said positioning-and-shading means is provided by a side wall of a frame accommodating said light guide plate.

4. A surface light source device in accordance with claim 2, wherein said positioning-and-shading means and said subsidiary positioning-and-shading means are provided by a side wall of a frame accommodating said light guide plate and said subsidiary light guide plate.

5. A surface light source device in accordance with claim 1, wherein a plurality of said positioning-projections are formed at locations along a length direction of said incidence face.

6. A surface light source device in accordance with claim 3, wherein a plurality of said positioning-projections are formed at locations along a length direction of said incidence face.

7. A surface light source device in accordance with claim 2, wherein a plurality of said positioning-projections are formed at locations along a length direction of said incidence face, and
a plurality of said subsidiary positioning-projections are formed at locations along a length direction of said subsidiary incidence face.

8. A surface light source device in accordance with claim 4, wherein a plurality of said positioning-projections are formed at locations along a length direction of said incidence face, and
a plurality of said subsidiary positioning-projections are formed at locations along a length direction of said subsidiary incidence face.

9. A display comprising:
a surface light source device; and
a displaying member illuminated by illumination light outputted from said surface light source device, wherein said surface light source device is in accordance with any one of claims 1 to 8.
